(19) United States
(12) Patent Application Publication
(10) Pub. No.: US 2019/0096263 A1
(43) Pub. Date: Mar. 28, 2019

(54) VEHICLE STATE RECORDING DEVICE

(71) Applicant: ISUZU MOTORS LIMITED, Tokyo (JP)

(72) Inventor: Hideto HIRAHARA, Yokohama-shi, Kanagawa (JP)

(21) Appl. No.: 16/081,964

(22) PCT Filed: Mar. 1, 2017
(86) PCT No.: PCT/JP2017/008088

§ 371 Date: Sep. 4, 2018

(30) Foreign Application Priority Data
Mar. 2, 2016 (JP) 2016-040119

(51) Int. Cl. G08G 1/00; G07C 5/00; G07C 5/08

(52) U.S. Cl. CPC G08G 1/205; G07C 5/085; G07C 5/0808; G07C 5/008

(57) ABSTRACT

A vehicle state recording device 100 is provided with the following: a device group 120 that outputs operation information which indicates the operating states of devices installed in a vehicle; a position detection unit 130 that acquires position information of the vehicle; an accident detection unit 140, a dangerous traveling detection unit 150, and an ABS operation sensor 160 that function as an event detection unit which outputs event information indicating the behavior of the vehicle; and a data recording device 110 that records the operation information, the position information, and the event information in association with each other.

### TECHNICAL FIELD

The present disclosure relates to a vehicle state recording apparatus.

### BACKGROUND ART

There have been vehicle state recording apparatuses which record operation states of vehicle-mounted devices (see, e.g., Patent Literature (hereinafter, referred to as “PTL”) 1). With this kind of apparatus, an operation time of each device, a value of a current which has flowed through each device, and/or the like are recorded in a data recording apparatus. The contents that have been recorded in the data recording apparatus can be thus utilized for failure diagnosis of devices, development of new devices, and/or the like.

### CITATION LIST

### Patent Literature

### PTL 1

Japanese Patent Application Laid-Open No. H10-030492

### SUMMARY OF INVENTION

### Technical Problem

Meanwhile, recording the operation states of devices alone in the manner described above does not make it possible to know under what conditions the devices are operated, and is thus considered insufficient in order to know a cause and/or the like of behavior of a vehicle. It is considered very convenient that it is possible to know, from the recorded data, whether or not the behavior (accident, unsafe traveling, and/or the like) of a vehicle has caused the operation of the device.

An object of the present disclosure is thus to provide a vehicle state recording apparatus capable of recording data that makes it possible to more accurately know a cause-and-effect relationship between an operation of a device and behavior (accident, unsafe traveling, and/or the like) of a vehicle.

### Solution to Problem

A vehicle state recording apparatus according to an aspect of the present disclosure includes: at least one sensor configured to output operation information indicating an operation state of a device mounted in a vehicle; a position detection section configured to acquire position information of the vehicle; at least one event detection section configured to detect behavior of the vehicle and to output event information indicating the behavior; and a recording section configured to record the operation information, the position information, and the event information in association with each other.

### Advantageous Effects of Invention

According to the present disclosure, device operation information, vehicle position information, and event information which indicates behavior of a vehicle are recorded in association with each other, so that it is made possible to achieve a vehicle state recording apparatus capable of recording data that makes it possible to more accurately know a cause-and-effect relationship between an operation of a device and behavior (accident, unsafe traveling, and/or the like) of a vehicle.

### BRIEF DESCRIPTION OF DRAWINGS

FIG. 1 is a block diagram illustrating a schematic configuration of a vehicle state recording apparatus according to an embodiment of the present disclosure; and

FIG. 2 is a diagram provided for describing data to be recorded in a data recording apparatus.

### DESCRIPTION OF EMBODIMENTS

Hereinafter, an embodiment of the present disclosure will be described in detail with reference to the accompanying drawings.

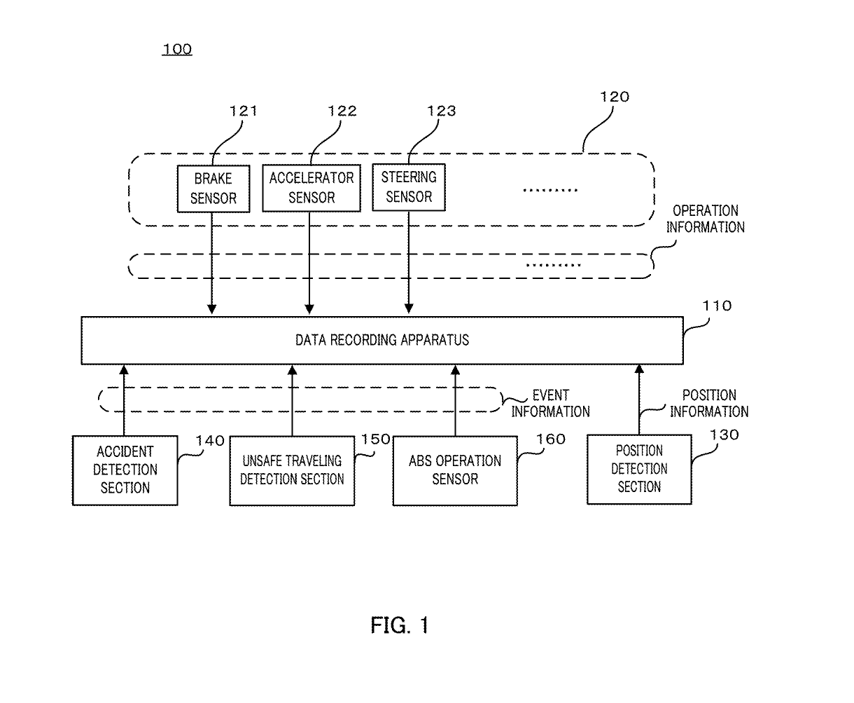

FIG. 1 illustrates a configuration of a vehicle state recording apparatus according to the present embodiment. Vehicle state recording apparatus 100 includes data recording apparatus 110. Data recording apparatus 110 is connected to a plurality of devices (device group 120) mounted in a vehicle, and is capable of recording operation states of the plurality of devices for the operations of the devices performed by a driver.

In an example of FIG. 1, operation information, such as brake information from brake sensor 121, accelerator information from accelerator sensor 122, and/or steering information from steering sensor 123, is inputted into data recording apparatus 110, and data recording apparatus 110 records these pieces of operation information.

The brake information indicates an operation state of the brake by the driver, the accelerator information indicates an operation state of the accelerator by the driver, and steering information indicates an operation state of the steering by the driver.

Moreover, data recording apparatus 110 records position information detected by position detection section 130. Position detection section 130 is a GPS sensor mounted in a vehicle, for example.

Moreover, when an accident of an vehicle for which vehicle state recording apparatus 100 operates (hereinafter, the vehicle is referred to as an “operation-target vehicle”) is detected by accident detection section 140, data recording apparatus 110 records this as accident information. Accident detection section 140 is composed of a collision detection sensor, for example.

Moreover, when unsafe traveling detection section 150 detects that the operation-target vehicle performs unsafe traveling, data recording apparatus 110 records this as unsafe traveling information. Unsafe traveling detection section 150 detects that unsafe traveling has been performed, when unsafe traveling detection section 150 determines that overspeeding, sudden steering, and/or sudden braking has been performed, based on, for example, vehicle speed information, steering information and/or brake information.

Moreover, data recording apparatus 110 records antilock brake system (ABS) operation information from ABS operation sensor 160.

Accident detection section 140, unsafe traveling detection section 150, and ABS operation sensor 160 herein function as an event detection section which detects an accident, unsafe traveling, and a slip, as event information of a vehicle. The event information as used in the present embodiment means “behavior (operation) of an automobile” as a result of an operation performed by a driver.

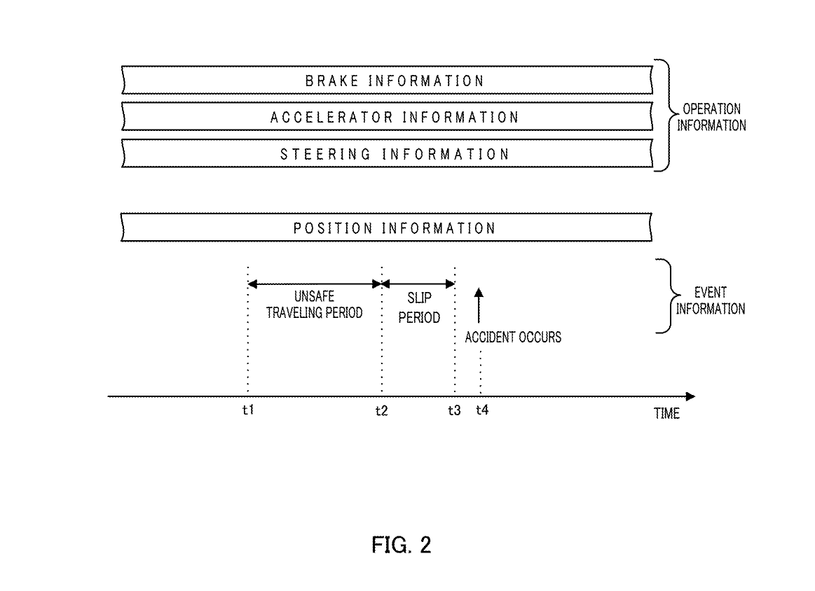

Data recording apparatus 110 records the operation information, position information, and event information with the same time axis; in other words, in association with time. FIG. 2 is a diagram illustrating how they are recorded in this manner. The operation information, such as brake information, accelerator information, and/or steering information is successively recorded in the time axis direction, and position information is also successively recorded in the time axis direction. Furthermore, the following are recorded as the event information: an unsafe traveling period (t1-t2) for which unsafe traveling is detected by unsafe traveling detection section 150; a slip period (t2-t3) for which a slip is detected by ABS operation sensor 160; and an accident occurrence time (t4) for which an accident is detected by accident detection section 140. Note that, although the unsafe traveling period and the slip period are successive in the example illustrated in FIG. 2, naturally, these periods may be apart from each other or may overlap with each other.

As described above, vehicle state recording apparatus 100 of the present embodiment records the operation information, position information, and event information in association with each other, so that it is possible to know, with reference to the recorded information, an operation state of each device when an event (such as an accident, slip, and/or unsafe traveling) has occurred, and also to know, for example, whether a cause of the event is mainly present in the device or is a road environment (unsafe location, such as a sharp curve) taking into account the position information at the time of the event.

The embodiment above is only illustration of an exemplary embodiment for implementing the present invention, and the technical scope of the present disclosure shall not be interrupted restrictively by the embodiment. More specifically, the present disclosure can be implemented in a variety of forms without departure from the gist or the primary features of the present disclosure.

This application is based on Japanese Patent Application No. 2016-040119, filed on Mar. 2, 2016, the disclosure of which is incorporated herein by reference in its entirety.

### INDUSTRIAL APPLICABILITY

The vehicle state recording apparatus of the present invention is applicable to vehicle state recording apparatuses which record operation states of devices mounted in vehicles.

### REFERENCE SIGNS LIST

100 Vehicle state recording apparatus
110 Data recording apparatus
120 Device group 120
121 Brake sensor
122 Accelerator sensor
123 Steering sensor
130 Position detection section
140 Accident detection section
150 Unsafe traveling detection section
160 ABS operation sensor

1. A vehicle state recording apparatus, comprising:
at least one sensor configured to output operation information indicating an operation state of a device mounted in a vehicle;
a position detection section configured to acquire position information of the vehicle;
at least one event detection section configured to detect behavior of the vehicle and to output event information indicating the behavior; and
a recording section configured to record the operation information, the position information, and the event information in association with each other.

2. The vehicle state recording apparatus according to claim 1, wherein
the recording section is configured to record the operation information, the position information, and the event information in association with time.

3. The vehicle state recording apparatus according to claim 1, wherein
the at least one sensor includes at least one of a brake sensor, an accelerator sensor, and a steering sensor.

4. The vehicle state recording apparatus according to claim 1, wherein
the at least one event detection section includes at least one of an accident detection section, an unsafe traveling detection section, and an antilock brake system (ABS) operation sensor.
